(19) United States
(12) Patent Application Publication
(10) Pub. No.: US 2010/0026783 A1
(43) Pub. Date: Feb. 4, 2010

(54) METHOD AND APPARATUS TO ENCODE AND DECODE STEREOSCOPIC VIDEO DATA

(75) Inventors: Joseph Chiu, Pasadena, CA (US); Matt Cowan, Bloomingdale (CA); Greg Graham, Boulder, CO (US)

Correspondence Address: REAL D - Patent Department, by Baker & McKenzie LLP, 2001 Ross Avenue, Suite 2300, Dallas, TX, 75201, US

(73) Assignee: REAL D, Beverly Hills, CA (US)

(21) Appl. No.: 12/534,126

(22) Filed: Aug. 1, 2009

Related U.S. Application Data
(60) Provisional application No. 61/085,719, filed on Aug. 1, 2008.
(60) Provisional application No. 61/150,218, filed on Feb. 5, 2009.

(51) Int. Cl. H04N 13/00

(52) U.S. Cl. 348/43; 348/E13.001

(57) ABSTRACT

A method and apparatus for encoding or tagging a video frame provides a way to indicate, to a receiver, for example, whether the video content is 3-D content or 2-D content. A method and apparatus for decoding an encoded or tagged video frame provides a way, for a receiver, for example, to determine whether the video content is 3-D content or 2-D content. 3-D video data may be encoded by replacing lines of at least one video frame with a specific color or pattern. When a decoder detects the presence of the colored or patterned lines in an image frame, it may interpret them as an indicator that 3-D video data is present.

### CROSS REFERENCE TO RELATED APPLICATIONS

This application claims priority to U.S. Provisional Application Ser. No. 61/085,719, filed on Aug. 1, 2008 entitled “Method and Apparatus to Encode and Decode Stereoscopic Video Data,” and U.S. Provisional Application Ser. No. 61/150,218, filed on Feb. 5, 2009 entitled “Method and Apparatus to Encode and Decode Stereoscopic Video Data,” which are incorporated herein by reference for all purposes.

### TECHNICAL FIELD

This disclosure generally relates to stereoscopic displays, and more particularly, to a method and apparatus for encoding and decoding a stereoscopic video frame or data, so that it can be identified as stereo video frames or data by a receiver, and be compatible with existing receiver infrastructure.

### BACKGROUND

Electronic stereoscopic displays offer benefits to viewers both for technical visualization and, more and more commonly, for entertainment. Cinema systems based on Texas Instruments Digital Light Processing (DLP) light engine technology and RealD polarization control components are being deployed widely in North America. Similar DLP technology is used in, for example, the Mitsubishi WD65833 Rear Projection television and the Samsung HL-T5676 RPTV. A different approach is used in the Hyundai E465S(3D) LCD television, which uses regularly arranged micro-polarizers bonded to an LCD display, such that circular polarized material alternately polarizes horizontal rows of pixels on the display. Thus, the 3D image is created by placing the left eye image into odd numbered rows and the right eye image in even numbered rows. The lenses in the 3D glasses are also polarized with material ensuring only the left eye sees the left image and vice versa. Yet another approach is used in the Samsung PN50A450P1D Plasma television. Different eyewear is used for polarization based versus time-sequential based 3-D, but these details are not germane to this disclosure.

The examples given above are all televisions that are capable of displaying both 2-D and 3-D content, but the formatting of the image data that is used when 3-D content is to be displayed is such as to render the images unwatchable if 2-D video data are (incorrectly) formatted as if they are 3-D data. This is currently handled in the products listed above by a viewer who manually switches the TV into “3-D mode” when 3-D content is to be played. This is typically done through menu selection. The specific formatting performed by the television itself or by a receiver depends on the technology used by the display device.

### BRIEF SUMMARY

The present disclosure provides a method and apparatus for marking, encoding or tagging a video frame to indicate that the content should be interpreted by a receiver, or suitably equipped display/TV, as 3-D video content. The present disclosure also provides a method and apparatus for identifying or decoding the tagged video frame to detect whether the content should be interpreted as 3-D video content.

In an embodiment, the 3-D video image, which is encoded in a transportable format such as side-by-side, is modified by replacing lines of the image with a specific pattern of color bars that are robust to compression, and are in essence improbable to occur within image content. When the receiver detects the presence of these color bars, it interprets them as a command to switch into 3-D mode.

### BRIEF DESCRIPTION OF THE DRAWINGS

FIG. 1 is a flow diagram illustrating an embodiment of a method for encoding or tagging a video frame to indicate that the content should be interpreted as 3-D video content, in accordance with the present disclosure;

FIG. 2 is a flow diagram illustrating an embodiment of a method for decoding the tagged video frame to detect whether the content should be interpreted as 3-D or 2-D video content, in accordance with the present disclosure;

FIG. 3 is a schematic diagram illustrating an embodiment of an image frame with a tag, in accordance with the present disclosure;

FIG. 4 is a schematic diagram illustrating another embodiment of an image frame with a tag, in accordance with the present disclosure;

FIG. 5 is a schematic diagram showing an expanded view of the lower left part of a black image with an embodiment of an identifying tag added, in accordance with the present disclosure;

FIG. 6 is a schematic diagram showing an expanded view of the lower left part of a black image with another embodiment of an identifying tag added, in accordance with the present disclosure;

FIG. 7 is a table showing an embodiment of the values of R, G and B data that may be used to create the tag, in accordance with the present disclosure;

FIG. 8 is a table showing an embodiment of the limit values of R, G and B data that may be used when detecting the tag, in accordance with the present disclosure;

FIG. 9 is a table showing another embodiment of the values of R, G and B data that may be used to create the tag, in accordance with the present disclosure;

FIG. 10 is a table showing another embodiment of the limit values of R, G and B data that may be used when detecting the tag, in accordance with the present disclosure;

FIG. 11 is a diagram of an embodiment of a decoding system, in accordance with the present disclosure,

FIG. 12 is a listing of Matlab code for an embodiment of a method for adding the tag to an image, in accordance with the present disclosure, and

FIG. 13 is a listing of Matlab code for another embodiment of a method for adding the tag to an image, in accordance with the present disclosure.

### DETAILED DESCRIPTION

It would be desirable for the television or receiver to determine automatically whether the incoming video data is intended to be displayed in 3-D or 2-D. This would have the benefit that the viewer would not have to manually adjust menu items or meddle with remote controls at the start of a 3-D movie. There are also other benefits such as allowing the producers of content to start a program in 2D mode, display a banner prompting the viewer(s) to “put your glasses on now”, and then switch the television into 3-D mode by changing the content to 3-D content.

Furthermore it is highly desirable that 3-D video content can be transmitted over the existing (2-D) video delivery infrastructure. Generally, content from delivery systems may be from streaming source(s) or may be from stored file(s). For example, such delivery systems may include, but are not limited to, DVD, Blu-Ray disc, Digital Video Recorder, Cable TV, Satellite TV, Internet and IPTV, and over-the-air broadcast, and the like. These delivery systems use various types of video compression, and for 3-D video content to be successfully transported over them, the 3-D data should be compatible with a number of compression schemes. One efficient scheme that has this property, is the side-by-side encoding described in commonly-owned U.S. Pat. No. 5,193,000, entitled “Multiplexing technique for stereoscopic video system,” to Lipton et al., which is hereby incorporated by reference. In this scheme, the left and right stereo frames are re-sampled to a lower resolution to allow them to be horizontally “squeezed” and placed side-by-side on a single 3-D frame. Because the resulting encoded image is itself an image (albeit with a boundary running down through the middle of it), it can be transported through any of the above-disclosed delivery systems.

Other related art in this field includes commonly-owned U.S. Pat. No. 5,572,250, entitled “Universal electronic stereoscopic display,” and U.S. Pat. No. 7,184,002, entitled “Above-and-below stereoscopic format with signifier” describe related systems and are herein incorporated by reference. Patent '250 describes a system in which a “tag” is embedded in time-sequential stereoscopic video fields to allow the system to determine whether the field that is being displayed at a given time is intended for the left or right eye. Patent '002 describes a system in which stereo fields are encoded in the top and bottom halves of a video image. A “tag” is included in the video data to help the system determine whether the field that is being displayed by a CRT should be sent to the left or right eye.

As disclosed herein, to address the problems discussed, a “tagging” technique may be used to modify image content in a frame to indicate whether visual content is to be treated as 2-D or 3-D by a receiver (as mentioned above).

Encoding an Image Frame to Indicate 3-D Video Content

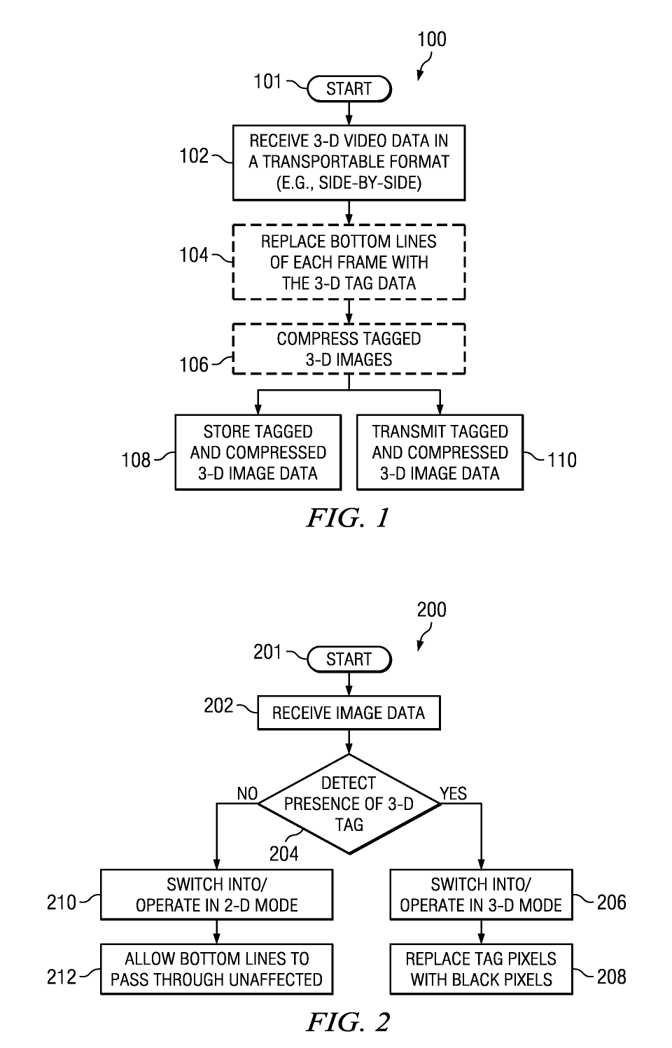

FIG. 1 is a flow diagram 100 illustrating an embodiment of a method for encoding or tagging a video frame to indicate that the content should be interpreted as 3-D video content.

The encoding process starts at step 101. In step 102, 3-D video data is received in a transportable format, for example side-by-side format. In other embodiments, the transportable format of the 3-D video data may be in up-and-down format, a temporally or spatially multiplexed format, or a Quincunx multiplexed format. Various transportable formats are disclosed above, but others may alternatively be used. The type of transportable format used is not germane to this disclosure.

Optionally, at least the bottom line of each frame is replaced with the 3-D tag data in step 104. In an embodiment, the bottom eight lines of each frame are replaced with the 3-D tag data. In another embodiment, the bottom two lines of each frame are replaced with the 3-D tag data. Other embodiments may vary the number of lines to be replaced with the 3-D tag data. A line of the frame or multiple lines of the frame are for illustrative purposes only and step 104 may be replaced with a step in which any portion of the image is replaced with a 3-D tag data. For example, in other embodiments, a watermark, a rectangular block, circle, or any predetermined shape in each frame may be replaced with 3-D tag data.

The most convenient way of adding the video tag depends on how the video data are created initially. The addition of the tag is a process that may be integrated into the generation of the video data, or it may be added subsequently by use of a stand-alone computer program.

Although this disclosure mostly discusses using the tag to identify whether the video data is 3D or not, a tag may be used to carry a number of unique pieces of information, not just whether the video is 3D. In either case, the tags may be constant throughout the entire video data, or may be dynamic (or changing) depending on the frame. The tag may be a predetermined specific color pattern or the tag may be modified dynamically in order to convey other information (e.g., real time information) that may affect the video conversion process. The simplest tag uses the entire tag to identify whether the content is 3D or not. The tag can be significantly redundant, and can carry more than a single piece of information. In other words, the tag can become a carrier of multiple pieces of information and this information could be changed depending on the frame. In an embodiment, the information is changed on a frame by frame basis. This “real time” information may include, but is not limited to, information about the characteristics of the content of a frame—like color space, dynamic range, screen size that the content was mastered for, and so on. In effect, the tag may be used as a means to carry metadata and can carry a wide variety of information. In an embodiment, in either case of the predetermined specific color pattern or the dynamic tag, the tag is robust in that the tag is unlikely to appear in naturally occurring non-stereoscopic video data.

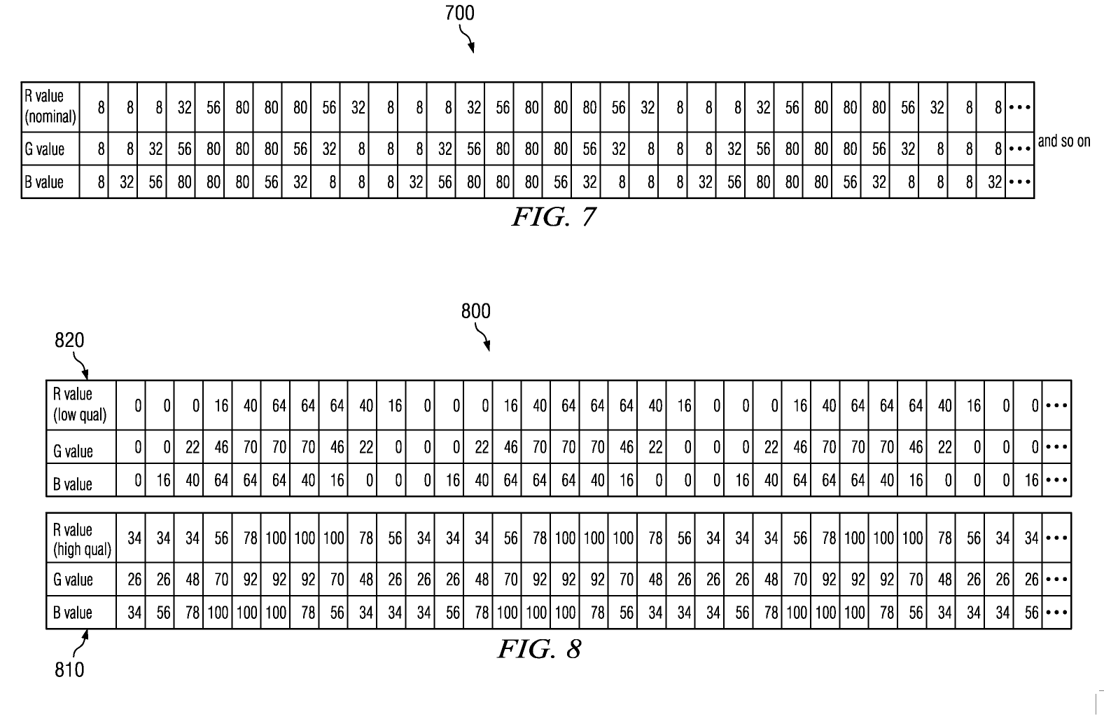

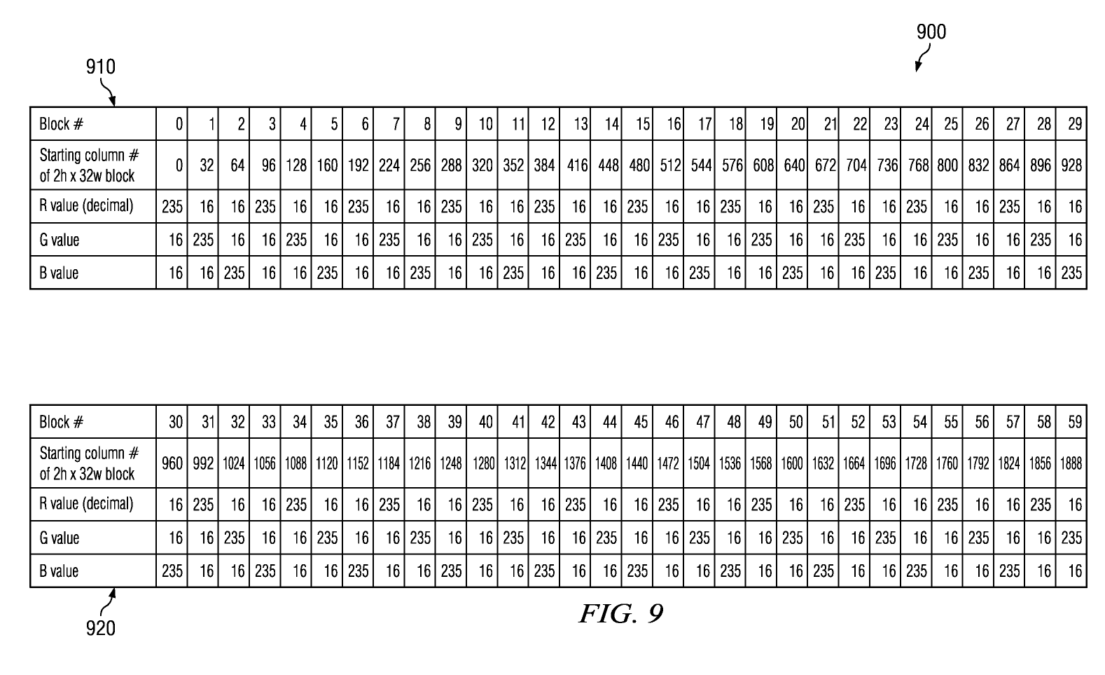

In an embodiment, exemplary pixel values of the video tag used are specified in the table of FIG. 7. In another embodiment, exemplary pixel values of the video tag used are specified in the table of FIG. 9. In an embodiment, FIG. 12 shows an exemplary embodiment of a piece of Matlab code that adds the tag to the bottom eight lines of a single image. In another embodiment, FIG. 13 shows an exemplary embodiment of a piece of Matlab code that adds the tag to the bottom two lines of a single image. This is easily extended to add the tag to a sequence of video frames, and it is to be understood that other software and hardware platforms may be more suited to specific applications.

The tagged image may then optionally be compressed using conventional compression techniques in step 106. Once compressed, the tagged image video data can be stored (step 108) and/or transmitted over video distribution channels (step 110). Transmitting the video data over standard video pathways (e.g., cable/satellite/terrestrial/broadband broadcast, streaming, DVD, Blu Ray discs, et cetera) typically include compression and/or decompression and chroma subsampling, and may include scaling.

In an embodiment, an advantage of the present disclosure is that the boundaries of the blocks of color in the video tag may be aligned with the boundaries of the blocks used by the popular MPEG2 compression scheme. This helps to preserve the integrity of the blocks even under severe compression. It should be noted that the steps may be performed in another order and that other steps may be incorporated into the process without departing from the spirit of the disclosure.

One advantage of using the bottom eight or two lines (as opposed to a smaller tag) is that it allows the tag to survive image corrupting processes (such as compression and decompression) with enough fidelity to be reliably detected. One advantage of using RGB stimulus values 16 and 235 (as opposed to 0 and 255) is more universal compatibility, and the fact that the receiver may be able to detect if color range expansion occurred in the playback path which may be useful in the event the receiver performs any color space processing.

Although an embodiment teaches the use of the bottom eight lines and another embodiment teaches the use of the bottom two lines of an image to carry the 3-D tag, it should be apparent to a skilled artisan that alternative encoding schema may be used, for instance using a different number of lines to encode, and/or placing the tag or tag lines in another part of the frame (e.g., the top part of the frame). The common elements between the disclosed embodiments are that the tag is present in the image data itself, and after being decoded, it is masked with other pixels (e.g., black pixels).

Decoding an Image Frame to Detect 3-D Video Content

FIG. 2 is a flow diagram illustrating a method for decoding the tagged video frame to detect whether the content should be interpreted as 3-D video content.

The decoding process starts at step 201. Conventional processing techniques such as using software, hardware, or a combination, for example, a processor running a software program, may be used to perform the decoding process. Image data are received at step 202. The image data may be compressed or uncompressed prior to the detection step 204. In the case that the image data are uncompressed prior to the detection step 204, the values of the data near the center of the color blocks may be examined to determine whether they are close enough to the tag value.

In an embodiment, after the video data are uncompressed, the receiver interrogates the pixel values. This can be done with a processor, logic inside a field-programmable gate array (FPGA), or application-specific integrated circuit (ASIC), for example. The receiver examines the values of the bottom line of pixels.

When a 3-D tag is detected at step 204, 3-D mode is indicated at step 206, thus triggering or switching into 3-D mode or continuing to operate in 3-D if already in that mode. The tag pixels are optionally replaced with black pixels at step 208. Referring back to detection step 204, if enough of these pixel values fall outside the allowed range, the 3-D tag is not detected, thus 2-D mode is indicated at step 210, thus triggering or switching into 2-D mode or continuing to operate in 2-D if already in that mode, and the bottom lines are allowed to pass through unaffected at step 212.

In an embodiment in which the bottom eight lines of an image carry the 3-D tag, the detection step 204 includes the receiver performing the following steps on the tag data residing in the last eight rows of the frame. In this embodiment, only the center part of the tagged data is examined. The first two rows and the final two rows of the eight lines of tag data are ignored. The center four rows are processed in the following manner.
i. Each row comprises a block of 16 pixels, and the first and last 4 pixels are ignored, leaving 8 pixels in the center of the block to be examined (this adds robustness and prevents errors in the decoding steps).
ii. Each remaining pixel is checked to see whether its RGB values fall within the allowed range. Consistent with this disclosed embodiment, an exemplary range that may be used is provided in the table of FIG. 8.
iii. Each time a pixel is outside its allowed range for one or more R, G, or B values an error count for that color is incremented.

For a frame, if the error count exceeds a predetermined threshold, then that frame is deemed to not carry the 3-D tag. If the error count for all of R, G and B is below the predetermined threshold then the frame is deemed to carry the 3-D tag. The thresholds used in this exemplary embodiment are also given in the table in FIG. 8. In an embodiment, two consecutive frames with fewer than 500 errors each for red and blue and fewer than 248 errors for green are used for positive detection.

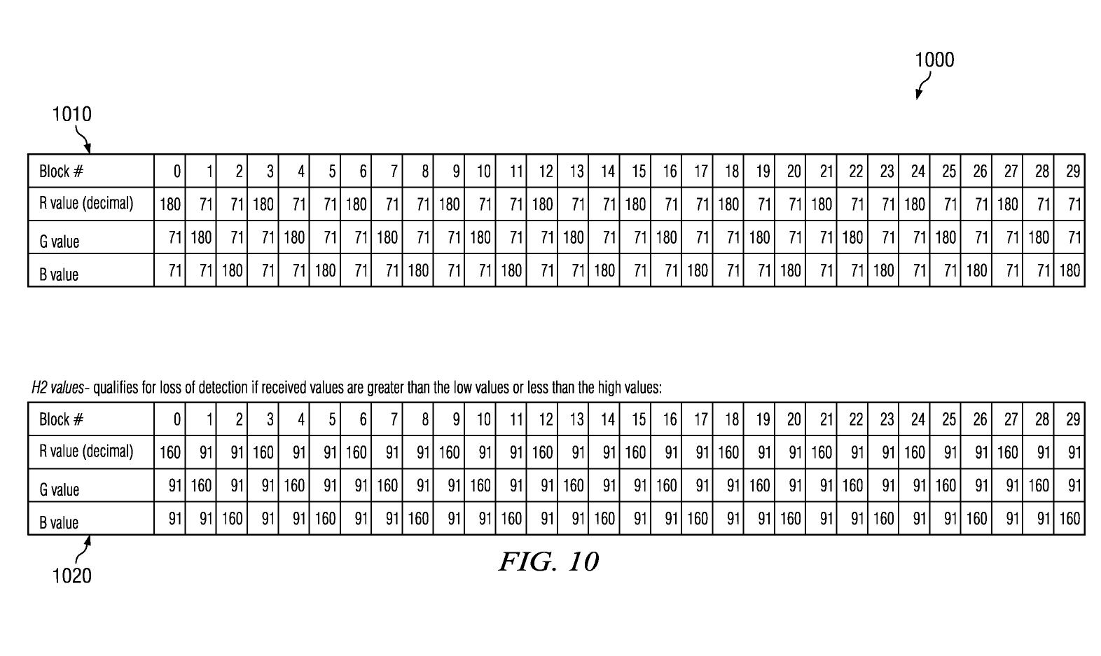

In an embodiment bottom in which the bottom two lines of an image carry the 3-D tag, the detection step 204 includes the receiver performing the following steps on the tag data residing in the last two rows of the frame. In this embodiment, only the second row of the tagged data is examined. The first row of tag data is ignored. The bottom row is processed in the following manner.
iv. Each row comprises a block of 32 pixels, and the first and last few pixels are ignored to add robustness. In an embodiment, the first and last 4 pixels are ignored, leaving 24 pixels in the center of the block to be examined.
v. Each remaining pixel (in an embodiment, the each of the remaining 24 pixels) is checked to see whether its RGB values fall within the allowed range. Consistent with this disclosed embodiment, an exemplary range that may be used is provided in the table of FIG. 10.
vi. Each time a pixel is outside its allowed range for one or more R, G, or B values an error count for that color is incremented.

For a frame, if the error count exceeds a predetermined threshold, then that frame is deemed to not carry the 3-D tag. If the error count for all of R, G and B is below the predetermined threshold then the frame is deemed to carry the 3-D tag. The thresholds used in this exemplary embodiment are also given in the table in FIG. 10.

In an embodiment, the receiver can switch immediately into or out of 3-D (or 2-D) mode on detection of the presence or absence of the tag or, optionally, can wait for a number of successive detections before making a change of state. This provides more immunity to noise at the cost of some delay in changing modes. For example, consistent with the disclosed embodiment, two successive detections of the tag may suffice to switch into 3-D mode and likewise, two successive detections of no tag may suffice to switch to 2-D mode.

To add further immunity to noise, mode transition hysteresis may be used for the three qualification parameters mentioned above: error count; value thresholds; and successive frame count. If hysteresis is used, in an embodiment, once in 3-D mode, more tolerant values of each of these parameters are used for tag disqualification to go back into 2-D mode. These values are also given in the tables in FIGS. 7 and 9.

The details of the 3-D operation mode of the receiver (which may reside inside a television or display) depend on the details of the technology used, and may use conventional 3-D operation techniques known in the art. A decoder module may be used and may include, e.g., software code, a chip, a processor, a chip or processor in a television or DVD player, a hardware module with a processor, etc. For example, the Hyundai E465S(3D) television, which is currently commercially available in Japan, can accept a video stream in the side-by-side format and reformat it to display in the row-interlaced format required by the x-pol technology. The Hyundai E465S television is instructed manually to perform this formatting operation via a menu selection. If that TV was modified consistent with the disclosed embodiments, it may switch automatically on receipt of content that was properly tagged.

In an embodiment, after switching into 3-D mode, the receiving system removes the tag and replaces the tag with other pixels. For example, the tag may be replaced with all black pixels or pixels of another color (e.g., to match a border color). Other replacement methods may also be used including pixel replication.

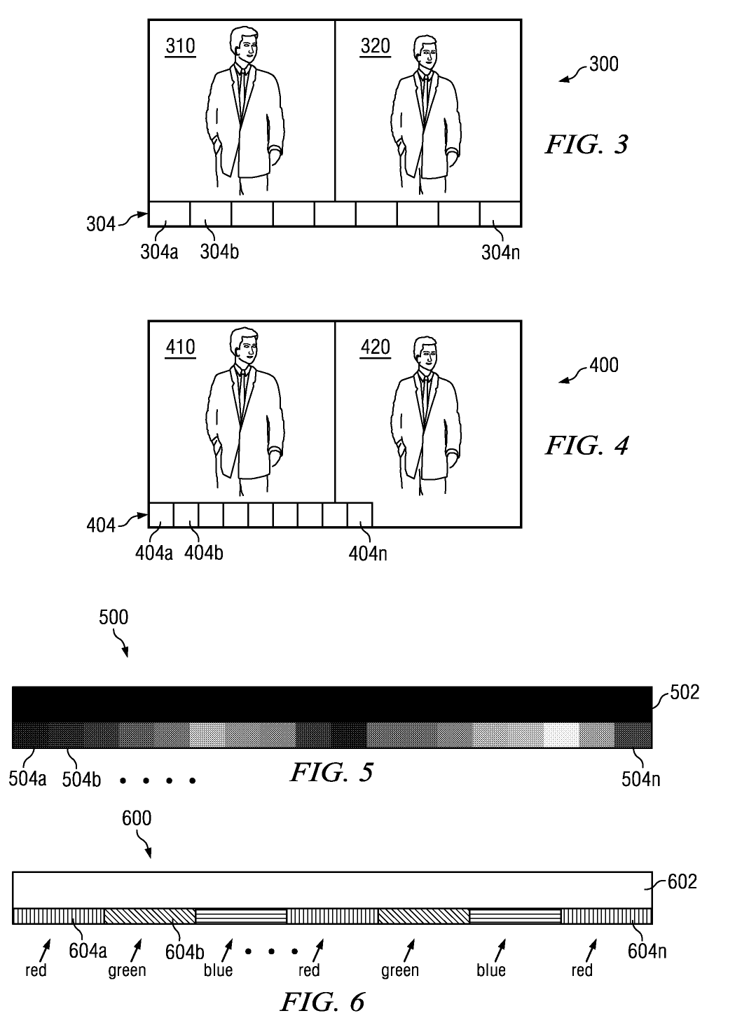

FIG. 3 is a schematic diagram illustrating an embodiment of an exemplary image frame 300. Image frame 300 includes a stereoscopic left image frame 310 and right image frame 320 with an exaggerated view of a tag 304 across the bottom of the image frame 300. The tag 304 comprises segments 304a-304n across the bottom of the image frame 300. In an embodiment, each segment 304a-304n is a different color than an adjacent segment and the colors repeat in a pattern throughout the tag 304. Image frame 300 is one example of a transportable format that includes left- and right-eye images in an image frame 300.

FIG. 4 is a schematic diagram illustrating another embodiment of an image frame 400 that includes stereoscopic left and right image frames 410, 420 with an exaggerated view of a tag 404. In this exemplary embodiment, the tag 404 is a rectangular shape that does not extend all the way across the bottom of the image frame 400. The tag 404 comprises segments 404a-404n. In an embodiment, each segment 404a-404n is a different color than an adjacent segment and the colors repeat in a pattern throughout the tag 404.

In the exemplary embodiments of FIGS. 3-6, the number of segments is represented by the number ‘n’ and is not limited to the number shown in the exemplary figures. Furthermore, showing the tags in the bottom portion of an image frame is for illustration purposes only. As discussed above, the tag may be positioned in any portion of the image frame and may comprise any shape.

FIG. 5 is a schematic diagram 500 illustrating a zoomed-in image of the lower left corner of an image with an exemplary eight-line “tag” 504a-504n added. The pattern of tag 504a-504n repeats all the way across the bottom of the image. Note that the color tag is deliberately dim with respect to the image content 502 so that it is less noticeable by viewers. In an embodiment, after the tag is decoded, an eight pixel high strip of black (not shown) may be used to replace the tag 504a-504n. The eight pixel high strip of black along the bottom of the image will generally not be visible in many systems due to the overscan that is typical in many TVs. In another embodiment, other colored or multi-colored pixels may be used to replace the tag. In systems where it can be seen, its effect is benign because a dark line of that height at the bottom of the screen will either be lost in existing “letterboxing” that is inherent in much content such as movies, or it is simply too small to be really perceptible as anything other than just part of the bezel.

FIG. 6 is a schematic diagram 600 illustrating a zoomed-in image of the lower left corner of an image with an exemplary two-line “tag” 604a-604n added. The pattern of tag 604a-604n repeats all the way across the bottom of the image in this exemplary embodiment. The image content 602 at the bottom of the image may be considered when determining the color of the tag 604a-604n.

FIG. 7 is a table 700 of exemplary pixel values for creating an embodiment of an eight-line “tag” added to an image. Each column shows three eight-bit color code values (RGB values), which should be displayed for all pixels in a 16-pixel wide, 8-pixel tall (corresponding to the bottom eight lines of the image) block. These blocks start at the bottom left corner of the frame and progress horizontally in the pattern shown to create a bar across the bottom of the frame (e.g., 1920 pixels wide for 120 blocks in a frame).

FIG. 8 is a table 800 of an embodiment of pixel values for detecting whether an eight-line “tag” has been added to an image. The table 800 provides high values 810 and low values 820 used to detect the presence of the tag. As discussed above, in an embodiment, the center 4×8 pixel block of each 8×16 pixel block is checked.

FIG. 9 is a table 900 of exemplary pixel values for creating an embodiment of a two-line “tag” added to an image. A two-line tag occupies the bottom two rows of each frame of video (e.g., lines 1078 and 1079 for 1080 pixel images). The tag consists of a repeating RGB pattern of 2h×32w pixel blocks, where each of the 64 pixels of a given 2×32 block has the same RGB code. In an embodiment, for a 1080 pixel image size, the pattern under the left half of the image is shown in FIG. 9 as 910 and the pattern under the right half of the image is shown in FIG. 9 as 920. In an embodiment, there is a pattern phase shift half way across the screen, causing two consecutive “blue” blocks. This adds robustness of pattern detection assuming the content is in Stereo SbS format.

For a 720 pixel image size, the tag is still two lines high, but the width of all blocks are scaled down by a factor of 1.5 (e.g., as if the player had scaled down a 1080 pixel source image for a 720 pixel display).

FIG. 10 is a table 1000 of an embodiment of pixel values for detecting whether a two-line “tag” has been added to an image. In this embodiment, only the bottom row is checked since the top row of the tag may have codec corruption from neighbor pixels above. As discussed above, three types of hysteresis may be used in the detection of the tag: frame count, error count, and code values. In an embodiment, two consecutive frames with fewer than 250 error pixels each for red, blue and green (using the 1010 values) are used for positive detection. Once detected, four consecutive frames of more than 350 error pixels each for either R, G, or B (using the 1020 values) are used to lose detection. E.g., the RGB values would qualify for detection based on the 1010 values if the received values are less than the low values and greater than the high values. In contrast, the RGB values would qualify for loss of detection based on the 1020 values if the received values are greater than the low values or less than the high values. While in the “detected” state (i.e., the 3-D state), the bottom two rows will be blanked such that the tag will not be visible if the display happens to be in a mode where all pixels are visible.

As discussed above, a decoder module may be used to decode any video data stream including at least one video frame and determine whether that video data includes a 3-D content identifier or tag.

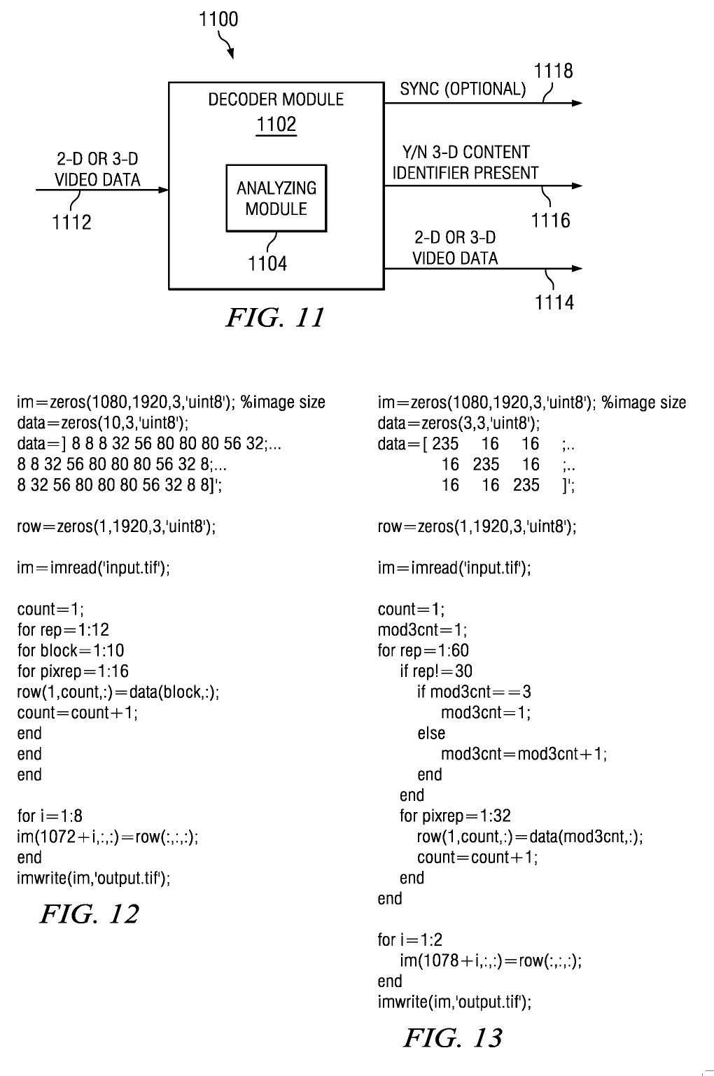

FIG. 11 is a system level diagram 1100 of an exemplary decoder module 1102. The decoder module 1102 includes at least one analyzer module 1104, a video input 1112, a video output 1114, and a content identifier output 1116. Optionally, decoder module 1102 may include a sync output 1118

In operation, the decoder module 1102 receives either 2-D or 3-D video data via input 1112. The analyzer module 1104 analyzes a portion of at least one frame of the video data and determines whether that data carries a 3-D content identifier. The analyzed portion of the image frame may include at least one line, multiple lines, or any other shape or block of pixels. The decoder module 1102 may output a signal or bit (or bits) indicating whether the 3-D content identifier is present 1116. The decoder module 1102 may also output the video data stream via video output 1114. In an embodiment, the decoder module 1102 removes a detected 3-D content identifier before outputting the video data stream. In another embodiment, the decoder module 1102 can output a signal or bit (or bits) for left/right image synchronization for 3-D data over sync output 1118. The decoder module 1102 may comprise, for example, software code, a system on a chip, a processor, a chip or processor in a television or DVD player, a set-top box, a personal computer, a hardware module with a processor, et cetera.

The decoder module 1102 may also include a receiving module (not shown in this figure) for receiving the 2-D or 3-D video data and an indicating module. The receiving module can receive the 2-D or 3-D video data. The indicating module uses the information from the analyzer module 1104 (the determination of whether a 3-D content identifier is present) and may provide a signal or bit (or bits) indicating that one of either a 3-D mode or 2-D mode. The decoder module 1102 may also include an image writing module (not shown in this figure) for replacing the pixels of the 3-D content identifier with other pixels. In an embodiment, the image writing module replaces the 3-D content identifier with black pixels, such that the viewer will be unable to see any tag information (however minimal) on the viewing screen, other than a hardly-noticeable thin black bar.

FIG. 12 is a listing of exemplary Matlab code for adding a video tag to the bottom eight lines of an input image and writing it out as a file entitled “output.tif”. FIG. 13 is a listing of exemplary Matlab code for adding a video tag to the bottom two lines of an input image and writing it out as a file entitled “output.tif”.

As used herein, the term “transportable format” refers to a format in which 3-D image content for left- and right-eye images is transported via the 2-D delivery infrastructure, which includes transportation via communications links (e.g., internet delivery of streaming media, video files, and the like) and/or storage media (e.g., DVD, Blu Ray disc, hard drives, ROM, and the like). Examples of such “transportable formats” include but are not limited to side-by-side, top-bottom, quincunx multiplexing, temporal/spatial modulation, or a combination thereof. As used herein, the terms “encoding,” is used synonymously with “marking,” and “tagging.” As used herein, the terms “decoding,” is used synonymously with “identifying.”

While various embodiments in accordance with the principles disclosed herein have been described above, it should be understood that they have been presented by way of example only, and not limitation. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A method for encoding stereoscopic video data containing at least one image frame, the method comprising modifying a portion of the image frame to carry a 3-D content identifier.

2. The method of claim 1, further comprising receiving the stereoscopic video data in a transportable format.

3. The method of claim 2, wherein the transportable format comprises a left eye image and a right eye image in each image frame.

4. The method of claim 1, further comprising compressing the modified stereoscopic video data.

5. The method of claim 4, further comprising one of storing or transmitting the compressed modified stereoscopic video data.

6. The method of claim 1, wherein the modifying a portion of the image frame comprises modifying at least a bottom-most row of the image frame with a 3-D content identifier.

7. The method of claim 6, wherein the modifying at least the bottom-most row of the image frame comprises modifying at least two bottom-most rows of the image frame.

8. The method of claim 6, wherein the modifying at least the bottom-most row of the image frame comprises modifying at least eight bottom-most rows of the image frame.

9. The method of claim 1, wherein the modifying a portion of the image frame comprises modifying at least a top-most row of the image frame with a 3-D content identifier.

10. The method of claim 1, wherein the modifying a portion of the image frame comprises modifying at least a left-most column of the image frame with a 3-D content identifier.

11. The method of claim 1, further comprising modifying a portion of a second image frame to carry a 3-D content identifier.

12. The method of claim 1, further comprising modifying a portion of alternating left-eye image frames and right-eye image frames to each carry 3-D content identifiers.

13. The method of claim 1, further comprising using a predetermined pattern for the 3-D content identifier, the predetermined pattern being unlikely to appear in naturally occurring non-stereoscopic video data.

14. The method of claim 1, wherein the modifying a portion of the image frame to carry a 3-D content identifier comprises modifying a portion of the image frame to carry a dynamic 3-D content identifier.

15. The method of claim 1, wherein the modifying a portion of the image frame to carry a 3-D content identifier comprises modifying a portion of the image frame to carry a predetermined 3-D content identifier.

16. A method for decoding stereoscopic video data containing at least one image frame carrying a 3-D content identifier, the method comprising analyzing a portion of the image frame to detect a 3-D content identifier embedded within the image frame.

17. The method of claim 16, further comprising receiving the stereoscopic video data.

18. The method of claim 16, further comprising:
when the 3-D content identifier is detected, indicating a 3-D decoding mode.

19. The method of claim 16, further comprising:
when the 3-D content identifier is not detected, indicating a 2-D decoding mode.

20. The method of claim 16, further comprising:
analyzing a portion of a second image frame to detect a 3-D content identifier embedded within the image frame, the second image frame consecutively following the image frame in the stereoscopic video data;
when the 3-D content identifier is detected in each of the image frame and the second image frame, indicating a 3-D decoding mode.

21. The method of claim 16, further comprising:
when the 3-D content identifier is detected, replacing pixels of the 3-D content identifier with replacement pixels.

22. The method of claim 16, wherein the analyzing a portion of an image frame comprises analyzing at least the bottom-most row of the image frame.

23. The method of claim 22, wherein the analyzing at least the bottom-most row of the image frame comprises analyzing the eight bottom-most rows of the image frame.

24. The method of claim 22, wherein the analyzing at least the bottom-most row of the image frame comprises analyzing the two bottom-most rows of the image frame.

25. The method of claim 22, wherein the analyzing at least the bottom-most row of the image frame comprises analyzing a central four rows of the eight bottom-most rows of the image frame.

26. The method of claim 22, wherein the analyzing at least the bottom-most row of the image frame comprises analyzing a central four rows of the eight bottom-most rows of the image frame.

27. The method of claim 16, wherein the analyzing a portion of an image frame comprises analyzing at least a top-most row of the image frame.

28. The method of claim 16, wherein the analyzing a portion of an image frame comprises analyzing at least a left-most column of the image frame.

29. The method of claim 16, wherein the analyzing a portion of an image frame comprises analyzing a central eight pixels of at least one row of the image frame.

30. The method of claim 29, further comprising determining whether each pixel of the central eight pixels is within predetermined RGB ranges.

31. The method of claim 30, further comprising toggling an error count when any pixel of the central eight pixels is outside of the predetermined RGB ranges.

32. The method of claim 31, further comprising:
when the error count exceeds a predetermined threshold, indicating detection of a 2-D content identifier; and
when the error count is below the predetermined threshold, indicating detection of a 3-D content identifier.

33. A method for encoding video data containing at least one image frame, the method comprising modifying a portion of an image frame to carry a tag.

34. The method of claim 33, further comprising determining the tag based on pieces of information about the image frame.

35. The method of claim 33, wherein the tag is dynamically generated.

36. A module to decode video data containing at least one image frame, the module comprising an analyzer module operable to analyze a portion of an image frame to determine whether a 3-D content identifier is embedded with the image frame.

37. The module of claim 36, further comprising a receiving module operable to receive the video data.

38. The module of claim 36, further comprising an indicating module operable to indicate one of a 3-D mode or 2-D mode.

39. The module of claim 36, further comprising an image writing module operable to replace pixels of the 3-D content identifier with black pixels.

40. The module of claim 36, wherein the analyzer module analyzes at least the bottom-most row of the image frame.

41. A module to decode video data containing at least one image frame, the module comprising an analyzer module operable to analyze a tag to determine pieces of information about the image frame.

42. A method for encoding a composite image frame to identify the carriage of 3D content, the method comprising:
modifying a portion of the composite image frame to replace image data with a 3D content tag, wherein the composite image frame comprises a left eye image frame and a right eye image frame.

43. The method of claim 42, wherein the 3D content tag is a graphical tag within the composite image frame.
